(19) United States
(12) Patent Application Publication
(10) Pub. No.: US 2026/0231847 A1
(43) Pub. Date: Aug. 13, 2026

(54) SYSTEMS AND METHODS FOR AUTOMATED CROP LOAD MANAGEMENT

(71) Applicant: Automated Fruit Scouting Inc., Spanaway, WA (US)

(72) Inventors: Matthew Charles King, Spanaway, WA (US); Daniel Legorreta, Buda, TX (US); Camila Tulyaganova, Rockville, MD (US)

(21) Appl. No.: 19/159,254

(22) PCT Filed: Feb. 22, 2024
(86) PCT No.: PCT/US2024/016903

§ 371 Date: Aug. 22, 2025

Related U.S. Application Data
(60) Provisional application No. 63/486,896, filed on Feb. 24, 2023.

(51) Int. Cl. A01B 79/00; G06T 7/00; G06T 7/60

(52) U.S. Cl. CPC A01B 79/005; G06T 7/0014; G06T 7/60; G06T 2207/20081; G06T 2207/30188

(57) ABSTRACT

Systems, methods, and articles for generating actions to meet one or more target metrics for crops based on crop data received via images. The systems disclosed herein generate target metrics for at least one crop and images depicting at least one aspect of at least one crop. The systems disclosed herein further identify aspects of the at least one crop based on the images and generate an indicator regarding the growth of the at least one crop based on the identified aspects. The growth indicator and identified aspects are used to predict whether one or more target metrics will be met by the at least one crop. An action to meet the target metrics is generated based on the growth indicator, the prediction, and the identified aspects.

### BACKGROUND

### Technical Field

The present disclosure relates to the field of computer technology, and more particularly, to computer systems and methods that facilitate crop management.

### Description of the Related Art

Growers manage and maintain crops throughout the lifecycle of the crop, typically to reach crop growth goals, or target metrics, by the end of a growing season. One such technique to reach their goals and manage and maintain their crops is crop load management. Precision crop load management involves pruning crops at certain stages in order to ensure each crop is able to reach the growth goals, or target metrics, set by the grower. Current methods of precision crop load management include counting and recounting aspects of the crop at each growth stage in order to determine whether each individual crop should be pruned or thinned.

### BRIEF SUMMARY

A method of operating a computer system to generate recommended actions to meet target metrics for a crop may be summarized as including: receiving one or more target metrics of at least one crop; receiving one or more images, each image including a depiction of at least one aspect of the at least one crop; identifying one or more aspects of the at least one crop based on the one or more images; generating at least one indicator regarding the growth of the at least one crop based on the identified one or more aspects of the at least one crop; determining whether the one or more target metrics will be met based on the at least one indicator and the target metrics; and generating one or more recommendations to meet the one or more target metrics based on the determination of whether the one or more target metrics will be met.

Identifying one or more aspects of the at least one crop may further include determining a size of the one or more aspects of the at least one crop based on the one or more images.

The determined size may be a trunk size, canopy size, plant size, or tree size, and generating at least one indicator regarding the growth of the at least one crop may further include: receiving historical data comprising historical crop size data and historical crop yield data for crops that have grown within a selected geographic area; and generating a potential crop yield for the at least one crop based on the historical data and the determined size, the potential crop yield for the at least one crop being a prediction of the crop yield for the at least one crop when no action is taken.

Generating one or more actions to meet the one or more target metrics may further include: determining an optimal crop load for the at least one crop based on the one or more target metrics, the determined size, and the historical data; and determining whether the at least one crop should be pruned based on the optimal crop load and potential crop yield.

The at least one aspect of the at least one crop may include fruitlets of the at least one crop, and generating at least one indicator regarding the growth of the at least one crop may further include: determining a first size of a plurality of fruitlets of the at least one crop based on the one or more images; receiving one or more images; determining a second size of a second plurality of fruitlets of the at least one crop based on the one or more additional images; and determining a growth rate of the fruitlets of the at least one crop based on at least the first size of the first plurality of fruitlets and the second size of the second plurality of fruitlets.

Determining the growth rate of the fruitlets may further include: receiving second one or more additional images; determining a third size of a third plurality of fruitlets of the at least one crop based on the one or more additional images; and determining the growth rate of the fruitlets of the at least one crop based on at least the first size of the first plurality of fruitlets, the second size of the second plurality of fruitlets, and the third size of the third plurality of fruitlets.

The at least one aspect of the at least one crop may grow on the at least one crop and generating the at least one indicator regarding the growth of the at least one crop may further include: determining a number of the at least one aspect depicted in the one or more images; and generating a prediction of the at least one aspect which have grown on the at least one crop based on the determined number of the at least one aspect depicted in the one or more images.

Generating the prediction of the number of the at least one aspect may further include: at a time after the one or more images are received, receiving additional one or more images, each image of the additional one or more images including a depiction of the at least one aspect of the at least one crop; determining a second number of the at least one aspect depicted in the additional one or more images; determining a change in the number of the at least one aspect which have grown on the at least one crop based on the number of the at least one aspect depicted in the one or more images and the second number of the at least one aspect depicted in the additional one or more images; and generating the prediction of the number of the at least one aspect which have grown on the at least on crop based on at least the determined change in the number of the at least one aspect which have grown on the at least one crop.

Generating the prediction of the number of the at least one aspect may further include: identifying at least one other aspect of the at least one crop; and applying the number of the at least one aspect depicted in the one or more images and the at least one other aspect to a machine learning model configured to generate a prediction of the at least one aspect growing on the crop based on a number of the at least one aspect and at least one other aspect of the at least one crop.

The at least one aspect that grows on the at least one crop may be at least one of: a bud, a bloom, a fruitlet, or a fruit.

The method may further include generating one or more dashboards based on the one or more target metrics and the at least one indicator regarding the growth of the at least one crop.

The target metrics may include one or more of: a crop yield, a bud yield, a bloom yield, a fruitlet yield, a fruit yield, a fruit size, or an orchard yield.

The actions may include one or more of: pruning branches, bloom thinning, fruitlet thinning, green fruit thinning, or continuing management of the crop without change. Thinning may be performed by hand, using chemical thinners, or other methods of thinning a crop. Pruning may be performed by hand, using chemical pruners, or other methods of pruning a crop. Green fruit thinning may be referred to as hand thinning.

A system used to generate actions to meet target metrics for crop management may be summarized as including: a camera; at least one processor; and at least one memory coupled to the at least one processor, the at least one memory having computer-executable instructions stored thereon that, when executed by the at least one processor cause the system to: receive, via user input one or more target metrics of at least one crop; receive, via the camera, a first set of one or more images of at least one aspect of the at least one crop; identify one or more aspects of the at least one crop based on the first set of one or more images; generate at least one indicator regarding the growth of the at least one crop based on the one or more aspects of the at least one crop; determine whether the one or more target metrics will be met based on the at least one indicator regarding the growth of the at least one crop and the one or more target metrics; and generate one or more actions to meet the one or more target metrics based on the determination.

To cause the at least one processor to identify one or more aspects of the at least one crop, the system may be further caused to: identify one or more scales within the first set of one or more images; and determine a size of the aspect of the at least one crop based on the first set of one or more images and the one or more scales.

To generate the one or more actions to meet the one or more target metrics, the system may be further caused to: determine, based on the one or more aspects of the at least one crop and the at least one indicator, a growth stage of the at least one crop; generate the one or more action based on the determination of whether the one or more target metrics will be met and the growth stage of the at least one crop; and present the one or more actions to a user.

The system may be further caused to: determine, based on the one or more aspects of the at least one crop and the at least one indicator, a growth stage of the at least one crop; generate one or more dashboards based on the one or more target metrics, the at least one indicator regarding the growth of the at least one crop; and present the one or more dashboards to a user.

A nontransitory processor-readable storage medium may store at least one of instructions or data, the instructions or data, when executed by at least one processor, may cause the at least one processor to: receive one or more target metrics of at least one crop; receive a first set of one or more images; identify one or more aspects of the at least one crop based on the first set of one or more images; generate at least one indicator regarding the growth of the at least one crop based on the one or more aspects of the at least one crop; and determine whether the one or more target metrics will be met based on the at least one indicator.

### BRIEF DESCRIPTION OF THE SEVERAL VIEWS OF THE DRAWINGS

FIG. 1 shows an example environment in which a precision crop load management system may operate, according to various embodiments described herein.

FIG. 2 is a block diagram depicting a sample precision crop load management system, according to various embodiments described herein.

FIG. 3 is a flow diagram of a process for generating actions to meet one or more growth goals based on a prediction, or determination, of whether growth goals will be met, according to various embodiments described herein.

FIG. 4 is a flow diagram depicting a process for obtaining one or more images of a crop via a user device, according to various embodiments described herein.

FIG. 5 is a flow diagram of a process for determining an optimal crop load for a crop according to various embodiments described herein.

FIG. 6A is a display diagram depicting an example image of a crop which is received by the precision crop load management system, according to various embodiments described herein.

FIG. 6B is a display diagram depicting an example image of a crop after the precision crop load management system has processed the image, according to various embodiments described herein.

FIG. 7 is a display diagram depicting a dashboard which may be generated by a precision crop load management system after determining an optimal crop load for one or more crops, according to various embodiments described herein.

FIG. 8 is a flow diagram depicting a process for determining whether buds growing on a crop should be pruned, according to various embodiments described herein.

FIG. 9A is a display diagram depicting an example image depicting buds growing on a crop, according to various elements described herein.

FIG. 9B is a display diagram depicting a sample image which has been processed by the precision crop load management system, and which depicts buds growing on a crop, according to various embodiments described herein.

FIG. 10 is a sample dashboard which may be generated by a precision crop load management system, according to various embodiments described herein.

FIG. 11 is a flow diagram depicting a process for determining whether at least one crop should be pruned based on the number of blooms growing on the at least one crop, according to various embodiments described herein.

FIG. 12 is a flow diagram of a process for determining whether fruitlets should be pruned, according to various embodiments described herein.

FIG. 13 is a display diagram of a graph which is used as part of a fruitlet growth model, according to various embodiments described herein.

FIG. 14A is a display diagram depicting an example image of a fruitlet measurement image received by the precision crop load management system, according to various embodiments described herein.

FIG. 14B is a display diagram depicting an example image of a fruitlet measurement image after a precision crop load management system has processed the image, according to various embodiments described herein.

FIG. 15 is a sample dashboard which may be generated by a precision crop load management system, according to various embodiments described herein.

FIG. 16 is a flow diagram depicting a process for determining whether green fruits should be pruned, according to various embodiments described herein.

FIG. 17A is a display diagram depicting an example image of crops bearing green fruit received by the precision crop load management system, according to various embodiments described herein.

FIG. 17B is a display diagram depicting an example image of crops bearing green fruit after a precision crop load management system has processed the image, according to various embodiments described herein.

FIG. 18 shows a processor-based device suitable for implementing the various functionality described herein.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

As used in this specification, a “crop” may refer to: a plant; a fruit, vegetable, flower, or grain that grows on a plant or tree; or any other cultivated plant or product of a cultivated plant.

One or more implementations of the present disclosure are directed to computer-implemented systems and methods of automating and optimizing the maintenance and management of crop growth goals. Crop growth management has traditionally been a manual and labor-intensive process which requires frequent measurements of each crop to be made by hand. Determining whether a crop is likely to meet growth goals, whether a crop should be pruned, and making other decisions related to the growth of a crop adds another layer of complexity to this process.

In conventional workflows a grower may use crop load management techniques, such as precision crop load management, in order to meet growth goals throughout the season and to meet a final crop load goal. Precision crop load management involves obtaining an initial measurement of the trunk of each plant to determine its crop load potential, followed by repeatedly counting and sizing buds, blooms, fruitlets, and green fruit to determine whether each crop should be pruned or thinned. The trunk may refer to the stem, trunk, or other aspect of the crop from which branches, roots, or other parts of a plant may grow.

However, in conventional workflows, each measurement performed as part of precision crop load is performed and recorded manually. This leads to inaccurate, inconsistent, or otherwise incorrect measurements of the crop, and requires a large amount of manual labor in order to obtain enough measurements to effectively perform the precision crop load management process. Furthermore, this data is not typically recorded for each crop or orchard, because it is difficult to manually keep track of the large number of crops in an orchard and because of the incorrect measurements of the crop. Thus, accurate historical data is not used to assist in determining the crop load potential of the tree.

Implementations of the present disclosure are directed to computer-implemented systems and methods for crop load management, managing growth goals for a crop, and obtaining accurate measurements of each crop included in an orchard, block of orchards, farm, or other area where crops are grown (a “precision crop load management system”). Thus, the aforementioned inefficient and unreliable processes are improved to provide better methods of managing the growth of a crop, measuring the crop, and recommendations for managing the crop.

Such implementations are thus able to improve the functioning of computer or other hardware, such as by reducing the processing, storage, and/or data transmission resources needed to perform a certain task, thereby enabling the task to be permitted by less capable, capacious, and/or expensive hardware device, and/or be performed with lesser latency, and/or preserving more of the conserved resources for use in performing other tasks. For example, by accurately recording historical trunk size data for crops, including the location of the crop, the implementations described herein are able to more quickly and more accurately determine the potential crop load for crops growing in the same orchard. These improvements are made by having access to a larger quantity of accurate data, which reduces the time and processing power needed to arrive at an accurate determination of the crop load as inaccurate data requires additional analysis and processing in order to obtain an accurate result. Furthermore, by automatically recording measurements regarding aspects of each of the crops, the data collected by implementations described herein is better organized than manually recorded data. The accuracy of the measurements, along with the superior organization and recordation of the data, results in fewer computing resources being used to manage, adjust, or otherwise “clean up” the data used in crop load management.

In at least some implementations, the precision crop load management system generates actions for growers to take in order to meet growth goals that they may set at the beginning of a growing season. These actions may include pruning aspects of the crop, such as buds, blooms, fruitlets, etc., allowing the crop to grow naturally, or other actions related to managing the crop load. The precision crop load management system may additionally determine the magnitude of the action, such as a number or percentage of the aspects of the crop to which the actions should be taken.

In at least some implementations, the precision crop load management system creates dashboards or other user interfaces which depict the progress of the crop in meeting the growth goals. The dashboards may be generated for each stage of the crop's lifecycle, and may include data relating to crops growing in multiple orchards.

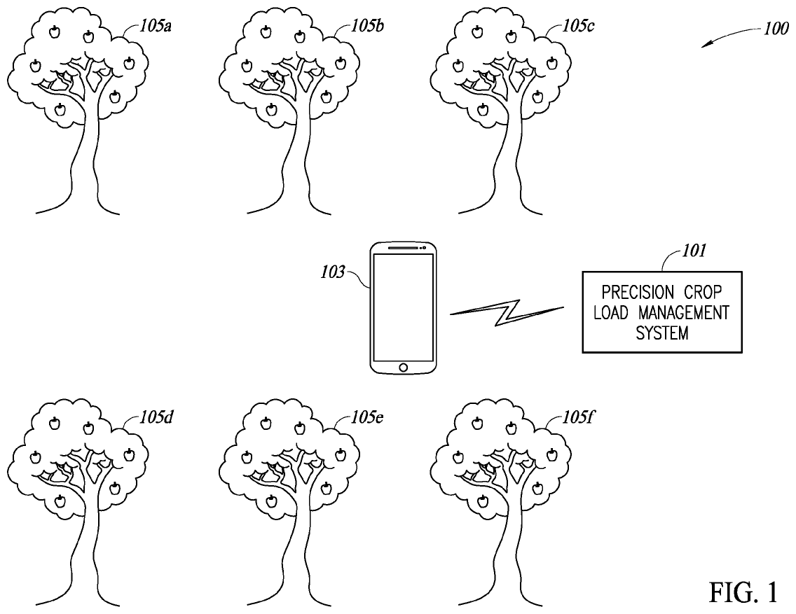

FIG. 1 shows an example environment 100 in which a precision crop load management system 101 may operate, according to various embodiments described herein. The environment 100 includes a precision crop load management system 101, a user device 103, and crops 105a-105f. The environment 100 may be an orchard, a block within an orchard, or any other location in which crops are grown. The user device 103 may be a computing device, telephone, smart phone, tablet, drone, or any other computing device which is able to obtain images regarding the crops 105a-105f and transmit those images to the precision crop load management system 101. Although a single user device 103 is depicted in the environment 100, embodiments are not so limited, and multiple user devices may be used in the environment 100. Likewise, although a single precision crop load management system 101 is depicted in the environment 100, embodiments are not so limited, and multiple precision crop load management systems may be used in the environment 100.

The precision crop load management system 101 may receive data regarding the crops 105a-105f from the user device 103. The precision crop load management system may additionally receive data regarding growth goals, the crops, etc., via user input. The user device 103 may be used by a user to obtain data regarding the crops 105a-105f, such as by obtaining images of one or more of the crops 105a-105f. The user device 103 and precision crop load management system 101 may transmit or receive data to or from each other via a wireless connection, a wired connection, the Internet or other computer networks, or via other methods of transmitting data to or from computing devices.

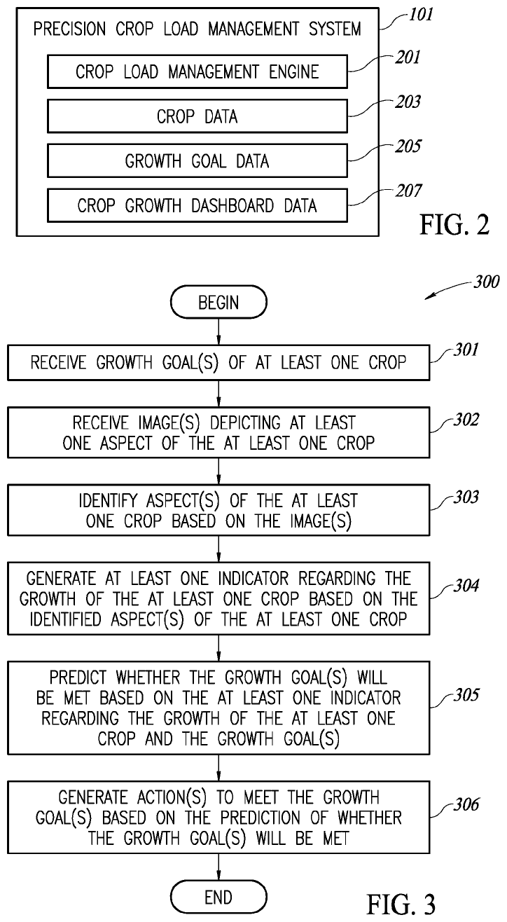

FIG. 2 is a block diagram depicting a sample precision crop load management system 101, according to various embodiments described herein. Aspects of the precision crop load management system 101 may operate on or include one or more computing devices, one or more servers, or any other combination of servers or computing devices. The precision crop load management system 101 may communicate with user devices located on an orchard, orchard block, etc., such as the user device 103. The precision crop load management system 101 may be able to receive user input related to the functions of the precision crop load management system 101. The precision crop load management system may include or have access to a display device, which may be used to display one or more dashboards generated by the precision crop load management system 101. In some embodiments, at least a portion of the aspects of the precision crop load management system are included in the user device 103.

The sample precision crop load management system 101 includes a crop load management engine 201, crop data 203, growth goal data 205, crop growth dashboard data 207, as well as other data, engines, software applications, hardware, etc., which may be used to perform the function of the precision crop load management system 101. The crop load management engine 201 uses the crop data 203, growth goal data 205, and crop growth dashboard data 207 to determine whether crop growth goals have been met, whether actions need to be taken to achieve growth goals, to display data regarding the crop growth and management to a user, and to perform any other functions of the precision crop load management system 101. The crop load management engine 201 may use any of processes 300, 400, 500, 800, 1100, 1200, or 1600 to perform the operations described herein.

The crop data 203 includes data related to one or more crops, such as crops 105A-105F. The crop data 203 may include one or more of: one or more images of one or more crops; data regarding the historical growth of the crops; statistical data regarding the growth of the crops; data regarding the impact of environmental conditions, such as changes in the weather, soil types, the amount or type of fertilizer given to the crops, or other environmental conditions related to crop growth, regarding the growth of the crops; or any other data related to the crops. The crop data may be obtained via one or more of: user input from a user device, such as the user device 103 described above in connection with one with FIG. 1; user input received at the precision crop load management system 101; a data source, dataset, database, etc., which includes crop data and which may be compiled, managed, or otherwise controlled by a user of the precision crop load management system 101, a user of a user device, or another entity (a “third party” entity); or any other input, dataset, repository, etc., which may include crop data.

The growth goal data 205 includes data regarding growth goals set for one or more crops, such as the one or more crops 103A-103G. The growth goal data may include one or more of: one or more desired crop loads; one or more optimal crop loads; one or more threshold or target metrics, such as a threshold bud count, threshold bloom count, threshold fruit count, threshold fruitlet count, or a count of any other aspect of a crop; one or more buffer thresholds; or any other growth goals which a grower may have. The growth goals may be goals for individual crops, orchards, orchard blocks, etc. The crop data may be obtained via one or more of: user input from a user device, such as the user device 103 described above in connection with one with FIG. 1; user input received at the precision crop load management system 101; generating the one or more growth goals based on user input; or other methods of receiving or generating growth goal data. The growth goal data 205 may be changed by the precision crop load management system 101, such as in response user input, based on crop data, or based on other input or data related to a change in a growth goal.

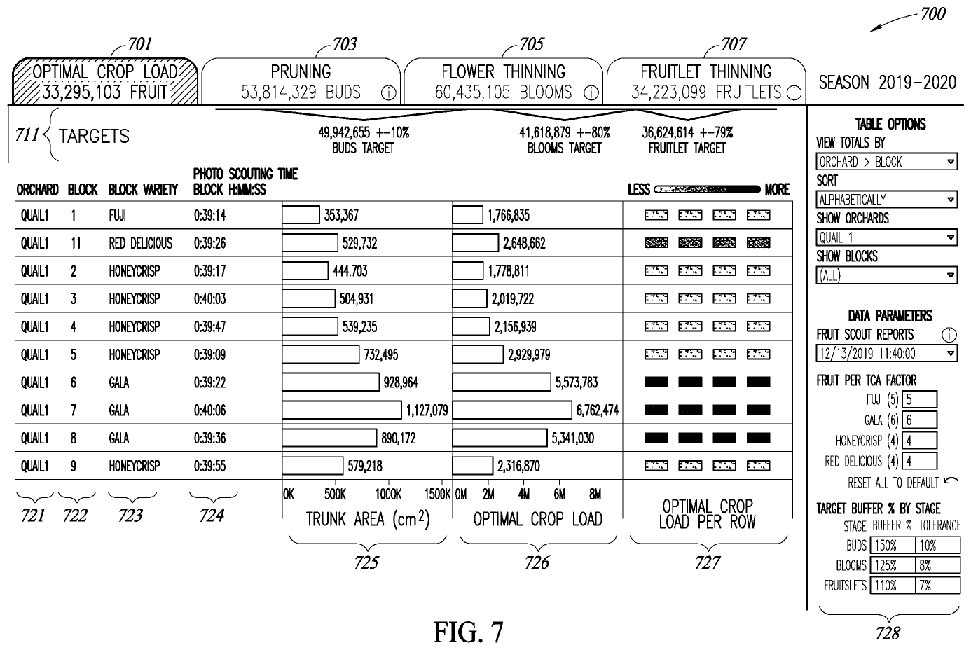

The crop growth dashboard data 207 includes data related to one or more dashboards created by the precision crop load management system 101, such as dashboards 700, 1000, and 1800 described below in connections in connection with FIGS. 7, 10, and 18 respectively. The crop growth dashboard data 207 may be generated by the precision crop load management system 101 based on one or more of: the crop data, the growth goal data, and user input. In some embodiments, the precision crop load management system 101 updates the growth goal dashboards in response to receiving new crop data or new growth goal data. For example, in such embodiments, the precision crop load management system 101 may update the growth goal dashboards in response to receiving one or more images of at least one crop, such that the growth goal dashboards are updated in near-real time.

FIG. 3 is a flow diagram of a process 300 for generating actions to meet one or more growth goals based on a prediction, or determination, of whether growth goals will be met, according to various embodiments described herein. The process 300 may be performed by a precision crop load management system, such as the precision crop load management system 101 described above in connection with FIG. 2. The process 300 begins, after a start block, at act 301, the precision crop load management system 101 receives one or more growth goals for at least one crop. The one or more growth goals may be or include growth goal data, such as the growth goal data 205 described above in connection with FIG. 2. The one or more growth goals may be received, obtained, generated, etc., in a similar manner to the growth goal data 205.

The process 300 proceeds to act 302, where the precision crop load management system receives one or more images depicting at least one aspect of the at least one crop. The one or more images may be received from one or more user devices, such as a user device 103 described above in connection with FIG. 1. In some embodiments, at least one image of the one or more images includes a scale which may be used to determine the size of at least one aspect of the one at least one crop. In some embodiments, the precision crop load management system uses the one or more images to generate at least a portion of the crop data used by the precision crop load management system, such as the crop data 203 described above in connection with FIG. 2.

The process 300 proceeds to act 303, where the precision crop load management system identifies one or more aspects of the at least one crop based on the one or more images. The one or more aspects of the at least one crop may be identified by applying the one or more images to one or more object recognition algorithms, such as a region-based convolutional network, region-based convolutional network, or any other supervised or unsupervised image processing, deep learning, or other object detection or object recognition techniques. For example, the precision crop load management system may use one or more object detection techniques to “count” aspects of a crop. In another example, the precision crop load management system may use one or more semantic segmentation techniques to size an aspect of a crop. The one or more aspects of the at least one crop may include one or more of: a trunk; a bloom; a fruit; a bud; a fruitlet; a color; or any other aspect of a crop.

The process 300 proceeds to act 304, where the precision crop load management system generates at least one indicator regarding the growth of the at least one crop based on the identified aspects of the at least one crop. In some embodiments, the indicator regarding the growth of the at least one crop includes one or more of: a size of the at least one aspect of the crop; a change in the size of the at least one aspect of the crop; an amount or number of the at least one aspect of the crop; a color of the at least one aspect of the crop; or other indicators regarding the growth of the crop.

The process 300 proceeds to act 305, where the precision crop load management system predicts whether the growth goals will be met based on the at least one indicator regarding the growth of the at least one crop and the growth goals. In some embodiments, the prediction of whether the growth goals will be met is based on statistical analysis, an artificial intelligence or machine learning model trained to output a prediction of whether a growth goal will be met, or any other method of predicting whether a growth goal will be met based on crop data. For example, the statistical analysis may include comparing historical data regarding the growth of the crop to crop data which includes the indicator regarding the growth of the at least one crop. In another example, a machine learning model may be trained based on historical data for similar crops to predict whether a growth goal of the at least one crop will be met based on at least one indicator regarding the growth of the at least one crop. The at least one indicator regarding the growth of the crop may be applied to the machine learning model to obtain the prediction of whether the growth goal will be met.

The process 300 proceeds to act 306, where the precision crop load management system generates one or more recommended actions to meet the growth goals based on the prediction of whether the growth goals will be met. The one or more actions may include one or more of: allowing the crop to grow without any intervention; pruning one or more aspects of the crop; thinning one or more aspects of the crop; altering a soil composition of the soil within which the crop grows; altering the amount of water that the crop receives; or any other actions which may affect the growth of a crop. The precision crop load management system may generate the one or more actions based on historical data, statistical analysis, an artificial intelligence or machine learning model trained to generate a recommended action based on growth goals and a prediction of whether the growth goals will be met, or other methods of determining a recommended action to meet a growth goal for a crop.

After act 306 the process 300 ends.

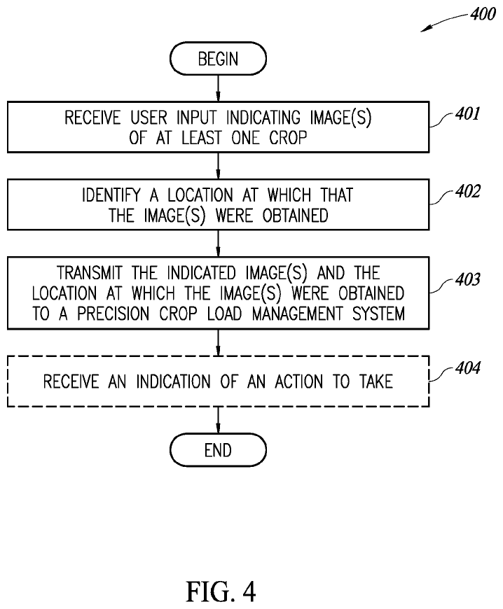

FIG. 4 is a flow diagram depicting a process 400 for obtaining one or more images of a crop via a user device, according to various embodiments described herein. A user device, such as the user device 103 described above in connection with FIG. 1, may perform the process 400. The process 400 begins, after a start block, at act 401, where the user device receives user input indicating one or more images of at least one crop. The indicated one or more images may be one or more of: images received via a camera connected to, or operated by, the user device, such as via a wired or wireless connection; images which are accessible to the user device, such as images stored locally, on cloud storage, or are otherwise accessible to a user device; or images which are received by the user device from another device.

The process 400 continues to act 402, where user device identifies a location at which the images were obtained. The location may be a GPS location, an orchard number, a block number, a crop number, or any other data which indicates a location at which an image of the at least one crop has been obtained. In some embodiments, the user device obtains the location of the image via one or more of: image metadata; user input; identifying one or more features of the image which indicate the location of the image; the activation of a location determination system of the user device, such as a GPS or other location determination system, when the image is taken; or other methods of obtaining a location at which an image is obtained, taken, received, etc. In some embodiments, at act 402, the user device determines, receives, or obtains a time at which the image was taken, such as via image metadata, user input, recording the time at which an image is taken, or other methods of determining a time at which an image is taken.

The process 400 proceeds to act 403, where the user device transmits the indicated images and the location at which the images were obtained to a precision crop load management system, such as the precision crop load management system 101 described above in connection with FIG. 2.

After act 403 the process 400 may end, or may optionally proceed to act 404, where the user device receives an indication of an action to take from the precision crop load management system. The received action may include instructions for a user of a user device to take the received take the indicated action. In some embodiments, the user device causes the received action to be displayed to a user of the user device.

After act 404 the process 400 ends. In some embodiments, the user device instructs a user of the user device to take a picture of another aspect of the at least one crop after the one or more images are obtained. For example, it may be determined that enough images of the blooms growing on a first crop have been obtained, and that the user should begin taking pictures of the blooms growing on another crop, such as a crop growing in the same block, orchard, or row as the first crop. As another example, it may be determined that the user device has obtained enough images of fruitlets growing on one crop, and that images of fruitlets growing on another crop should be obtained.

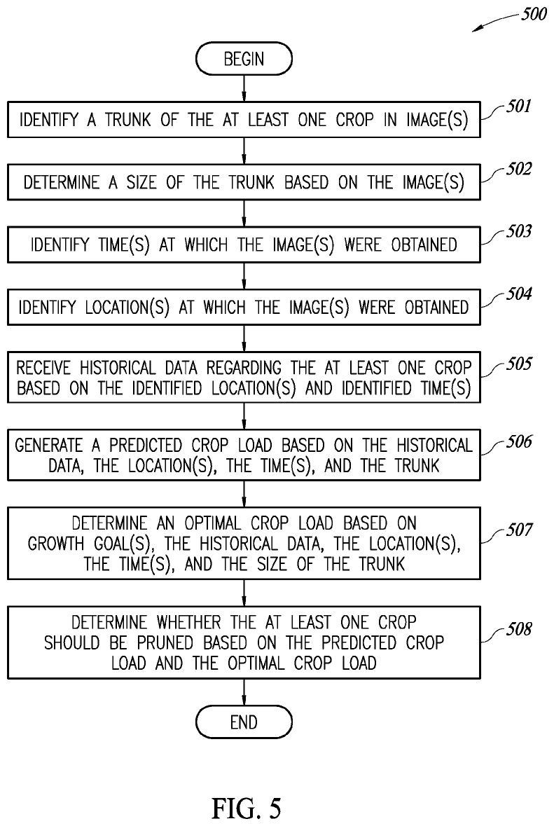

FIG. 5 is a flow diagram of a process 500 for determining an optimal crop load for a crop according to various embodiments described herein. The process 500 may be performed by a precision crop load management system, such as the precision crop load management system 101 described above in connection with FIG. 2. After start block, the process 500 begins at act 501, where the precision crop load management system identifies a trunk of the at least one crop in one or more images. The trunk may be identified process similar to the process described in act 303.

The process 500 proceeds to act 502, where the precision crop load management system determines the size of the trunk based on the one or more images. The precision crop load management system may determine the size of the trunk by identifying one or more scales within the one or more images, and using the identified scales to determine a size of the trunk.

The process 500 proceeds to act 503, where the precision crop load management system identifies one or more times at which the images were obtained. The process proceeds to act 504 where the precision crop load management system identifies one or more locations at which images were obtained. In some embodiments, the precision crop load management system performs one or more of acts 503 and 504 based on one or more of: metadata included in the one or more images, user input, data from a user device regarding the one or more images, or any other method of identifying a time or location at which an image was taken. In some embodiments, the locations include one or more of: an orchard, a block, a row, etc.

The process 500 proceeds to act 505, where the precision crop load management system receives historical data regarding the at least one crop based on the identified locations and the identified times. The historical data may be included in crop data, such as the crop data 203 described above in connection with FIG. 2. As an example, for a crop located within row three of block two of orchard one, the precision crop load management system may obtain historical data regarding this row. In another example, the precision crop load management system may obtain historical data for an entire block, an entire orchard, portions of blocks or orchards, etc., based on the location of the at least one crop.

Process 500 proceeds to act 506, where the precision crop load management system generates a predicted crop load based on the historical data, the locations that the one or more images were received, the times that the one or more images were received, and the trunk size. In some embodiments, the precision crop load management system determines the predicted crop load based on one or more of: statistical analysis, an artificial intelligence or machine learning model trained to output a predicted crop load based on historical data, trunk size, crop location, and the time that a trunk size was obtained, or any other methods of determining a predicted crop load for at least one crop.

The process 500 proceeds to act 507, where the precision crop load management system determines an optimal crop load based on one or more of: the growth goals, historical data, the locations that the one or more images were received, the times that the one or more images were received, and the trunk size. In some embodiments, the optimal crop load is determined based on user input, such as user input indicating a desired crop load, user input indicating one or more thresholds for the crop load, user input indicating one or more buffers for the crop load, or other user input. In some embodiments, the precision crop load management system is determined based on a combination of user input and one or more of: the growth goals, historical data, the locations that the one or more images were received, the times that the one or more images were received, and the trunk size.

The process 500 proceeds to act 508, where the precision crop load management system determines whether the at least one crop should be pruned based on the predicted crop load and the optimal crop load. For example, if the predicted crop load is greater than the optimal crop load the precision crop load management system may determine that the at least one crop should be pruned. In some embodiments, it may be determined that the at least one crop should be pruned when the difference between the predicted crop load and the optimal crop load is outside of a threshold range. For example, if the threshold range is ten percent, the predicted crop load is 100 and the optimal crop load is 95, the difference between the predicted crop load and the optimal crop load is within the threshold range (i.e. between 85 and 105), and the precision crop load management system would not determine that the crop should be pruned. In contrast, if the predicted crop load is 110, the difference between the predicted crop load and optimal crop load is not within the threshold range, and the precision crop load management system may determine that the crop should be pruned to bring it within the threshold range.

After act 508 process 500 ends.

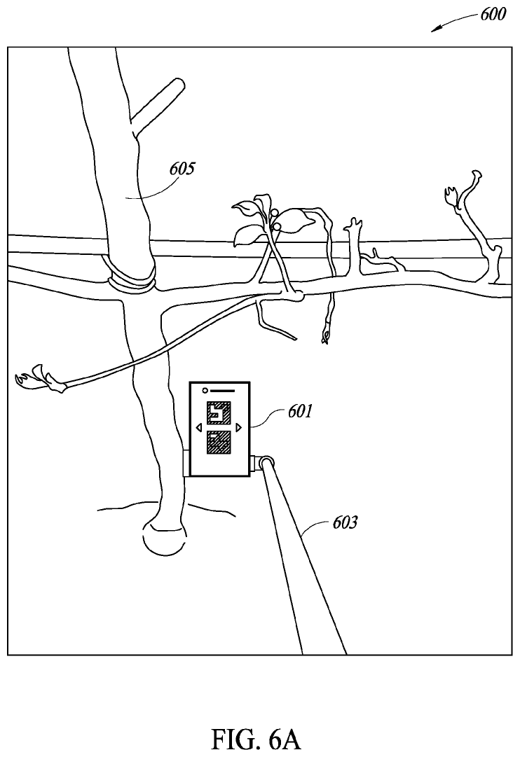

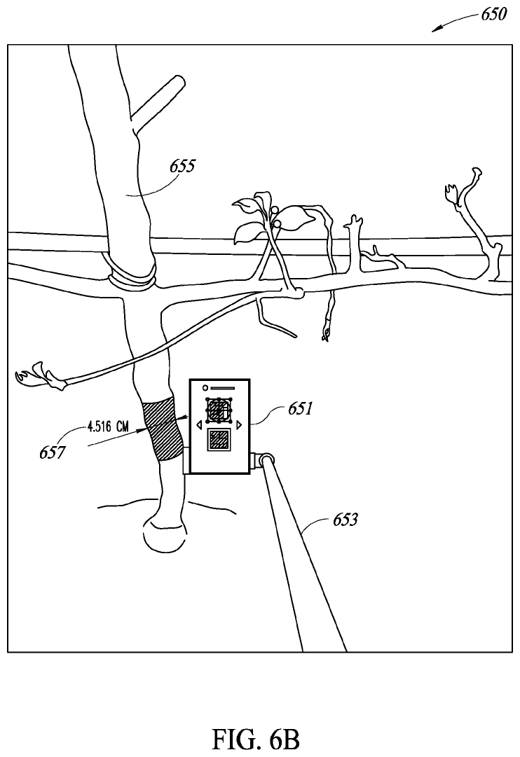

FIG. 6A is a display diagram depicting an example image 600 of a crop which is received by the precision crop load management system, according to various embodiments described herein. The image 600 includes a scale 601, a scale mount 603, and a crop 605. The image 600 is an example of an image which includes at least one aspect of a crop, such as the crop 605, which may be received by a precision crop load management system, such as the precision crop load management system 101. The scale 601 is a scale which may be used by the precision crop load management system to determine a size of at least one aspect of the crop, such as the trunk of the crop 605. The scale mount 603 is a mount for the scale 601 which allows a user to maneuver the scale 601 when obtaining the image 600.

FIG. 6B is a display diagram depicting an example image 650 of a crop after the precision crop load management system 101 has processed the image, according to various embodiments described herein. The image 650 includes a scale 651, a scale mount 653, a crop 655, and a measurement 657. The image 650 is an example of a result of the processing performed by precision crop load management system to obtain a trunk size of the crop. In some embodiments, the precision crop load management system may obtain data from processing the image 600 without generating the image 650. As can be seen in the image 650, the precision crop load management system has identified the scale 651 and the trunk of the crop 655, as shown by the shaded area of the crop 655. The precision crop load management system has obtained the measurement 657 by processing the image 600 to determine a measurement of the size of the trunk. The measurement 657 may be obtained by identifying a trunk of the crop, such as via the object recognition described above in connection with act 303, and comparing the size of the trunk to the scale 651, such as through the process 500 described above in connection with FIG. 5. In some embodiments, multiple measurements of the trunk are obtained by the precision crop load management system, and such measurements are used to identify one or more geometric properties of the trunk, such as an area, length, width, circumference, diameter, volume, or other geometric properties. Although in this example the image 650 is generated by the precision crop load management system, embodiments are not so limited, and the precision crop load management system may obtain data regarding the trunk size from the image 600 without generating the image 650.

FIG. 7 is a display diagram depicting a dashboard 700 which may be generated by a precision crop load management system after determining an optimal crop load for one or more crops, according to various embodiments described herein. In some embodiments the precision crop load management system generates the dashboard 700 after determining the optimal crop load of one or more crops, such as by performing the process 500 described above in connection with FIG. 5. The dashboard 700 includes a crop load tab 701, a pruning tab 703, a flower thinning tab 705, and a fruitlet thinning tab 707. The dashboard 700 additionally includes a target section 711, an orchard column 721, a block column 722, a block variety column 723, a photo scouting column 724, a trunk area column 725, an optimal crop load column 726, an optimal crop load per row column 727, and a table options section 728.

The crop load tab 701 indicates the total optimal crop load for crops associated with a grower, and selecting the optimal crop load tab 701 displays the dashboard 700. Likewise, selecting one of the pruning tab 703, flower thinning tab 705, or fruitlet thinning tab 707 may display another dashboard, such as the dashboards 1000, 1500, and 1800. The targets 711 indicate the target load for each growth stage of the crops associated with the grower. The orchard column 721 indicates the orchard for which data has been obtained. The block column 722 indicates the block within an orchard for which the data has been obtained. The block variety column 723 indicates a type of crop which is growing at the orchard and block specified in the orchard column 721 and block column 722 respectively. The photo scouting column 724 indicates the amount of time spent obtaining images of crops growing in the block specified in the block column 722.

The trunk area column 725 indicates the total trunk area for each crop included in the block indicated in the block column 722. The trunk area may be determined based on one or more trunk sizes, such as the trunk sizes obtained from one or more images via the process 500. The optimal crop load column 726 indicates the optimal crop load for the corresponding block specified in the block column 722. The optimal crop load for the corresponding block may be determined in a similar manner to act 507 of the process 500. The optimal crop load per row column 727 includes an indication of each row included in a block and an indication of the contribution of each row to the total crop load of the block. The precision crop load management system may determine the contribution of each row to the optimal crop load based on a location of each crop for which the optimal crop load was calculated. For example, the precision crop load management system may determine the orchard, block, and row within which a crop is located based on location data received with one or more images of the crop, and may use this determination to determine the contribution of each crop in a row to the optimal crop load.

The table option section 728 includes a variety of options for altering or changing the data displayed by the dashboard 700, such as viewing the totals for each crop based on the orchard and block, sorting the table, changing which orchards are included in the dashboard, viewing data based on selected blocks, changing which data is being used to populate the dashboard, and changing or altering buffer and tolerance percentage for each of the growth stages. The buffer indicates a threshold number of extra crops grown in order to ensure that the optimal crop load can be met if some of the corps are unable to grow, such as in the event of a natural disaster, crop disease, infestation, or other issues which may inhibit or prevent crops from growing. The tolerance percentage indicates a threshold range of the crop load within which the crop load should be maintained. For example, a buffer which indicates that during the bud stage, 150% of the optimal crop load should be growing, a tolerance percentage of 10% indicates that any crop load between 140% and 160% of the optimal crop load would be acceptable.

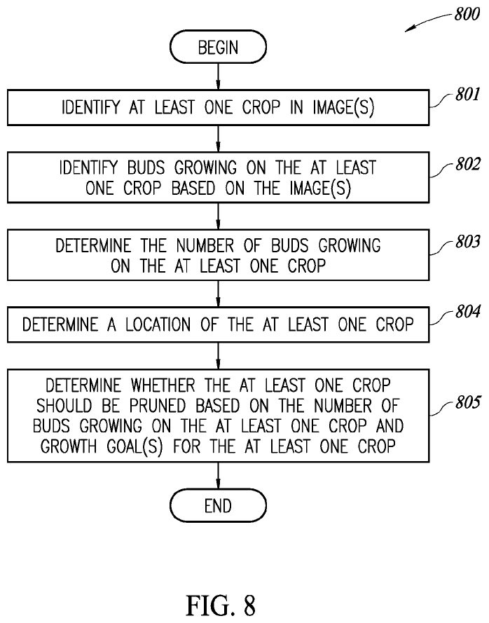

FIG. 8 is a flow diagram depicting a process 800 for determining whether buds growing on a crop should be pruned, according to various embodiments described herein. The process 800 may be performed by a precision crop load management system, such as the precision crop load management system 101 described above in connection with FIG. 2. The process 800 begins after a start block at act 801, where the precision crop load management system identifies at least one crop in the one or more images. The process 800 proceeds to act 802, where the precision crop load management system identifies one or more buds growing on the at least one crop based on the one or more images. In some embodiments, the precision crop load management system performs acts 801 and 802 in a similar manner to one or more of acts 303 and 501 described above in connection with FIGS. 3 and 5 respectively.

Process 800 proceeds to act 803, where the precision crop load management system determines the number of buds growing on the at least one crop. In some embodiments, to determine the number of buds growing on the at least one crop, the precision crop load management system identifies the buds visible in the one or more images, and determines the total number of buds growing on the at least one crop based on the visible buds. In some embodiments, the precision crop load management system uses the number of visible buds along with one or more of: prior historical data, a predicted crop load for the crop, a measure of the amount of the crop which is visible in the one or more images, age of the crop, size of the crop, a time of year, and other data indicating how many buds may be growing on a crop, to determine how many buds are growing on the crop.

For example, the precision crop load management system may determine that only half of the crop is visible, and that there are fifty visible buds. The precision crop load management system may then predict, based on the determination that half of the crop is visible and the fifty visible buds, that there are twice as many buds as visible buds, such that the total number of buds is one hundred. Thus, in such embodiments, the precision crop load management system is able to determine the total number of buds growing on a crop even when a portion of the buds are obscured or otherwise not identifiable in the one or more images. In some embodiments, as part of performing act 803, the precision crop load management system determines which visible buds are leaf buds and which visible buds are flower buds, such as by using image recognition models which are able to differentiate leaf buds from flower buds. In such embodiments the precision crop load management system might not take the leaf buds into account when obtaining the total bud count.

In some embodiments, to perform act 803, the precision crop load management system may receive one or more images of buds at a plurality of times. The precision crop load management system may use the one or more images of buds at the plurality of times to determine a change in the number of buds over time. The precision crop load management system may use the change in the plurality of buds to predict the total number of buds growing on the crop.

In some embodiments, at act 803, the precision crop load management system applies the number of visible buds and data regarding the crop to an artificial intelligence or machine learning model configured to predict a number of buds growing on the crop. The artificial intelligence or machine learning model may be trained to predict the number of buds growing on a crop based on a number of visible buds along with one or more of: prior historical data, a predicted crop load for the crop, a measure of the amount of the crop which is visible in the one or more images, age of the crop, size of the crop, a time of year, one or more images depicting the buds growing on the crop, and other data indicating how many buds may be growing on a crop.

The process 800 proceeds to act 804 where the precision crop load management system determines a location of at least one crop. In some embodiments the act 804 is performed in a similar manner to act 504 described above in connection with FIG. 5.

The process proceeds to act 805, where the precision crop load management system determines whether the at least one crop should be pruned based on the number of buds growing on the at least one crop and the growth goals for the at least one crop. In some embodiments, the precision crop load management system determines whether at least whether the at least one crop should be pruned by using historical data regarding the growth of the crop, statistical analysis, or an artificial intelligence or machine learning model configured to receive a number of buds and one or more growth goals and to output determination of whether the at least one crop should be pruned. In some embodiments, the precision crop load management system determines the number of buds which should be pruned based on the number of buds growing on the at least one crop and the growth goals. In some embodiments, as part of performing act 805, the precision crop load management system determines whether the one or more buds should be pruned via hand pruning or chemical pruning. The precision crop load management system may determine a manner of pruning the buds based on at least one of: a determination that one or more buds should be pruned, a number of buds which should be pruned, or one or more growth goals. In some embodiments, the precision crop load management system takes into account one or more buffers or tolerances when performing act 805.

After act 805, the process 800 ends.

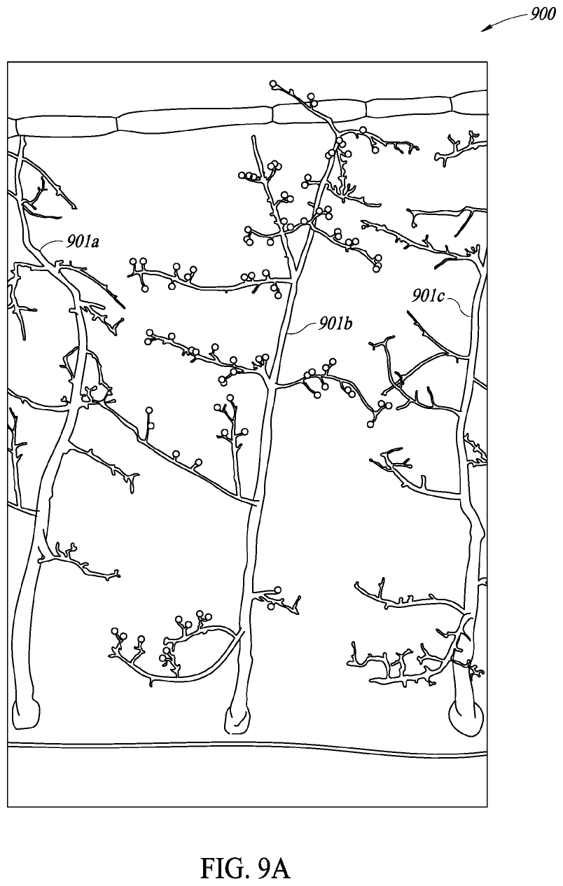

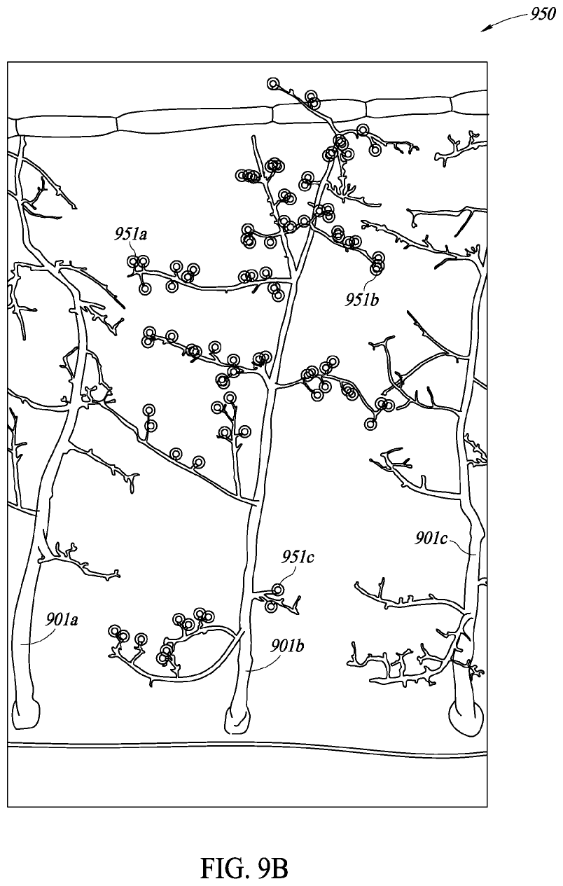

FIG. 9A is a display diagram depicting an example image 900 depicting buds growing on a crop, according to various elements described herein. The image 900 includes crops 901A, 901B, and 901C. The image 900 is an example of an image received by a precision crop load management system of a crop upon which buds are growing.

FIG. 9B is a display diagram depicting a sample image 950 which has been processed by the precision crop load management system, and which depicts buds growing on a crop, according to various embodiments described herein. The image 950 is an example of the result of the processing performed by precision crop load management system to obtain a bud count for the crop. The image 950 includes crops 901A, 901B, and 901C and buds 951a, 951b, and 951c (collectively “buds 951”). The buds 951 are identified by the precision crop load management system in a similar manner to act 802 described above in connection with FIG. 8. In the image 950, the buds 951 are circled to indicate that the precision crop load management system has identified the buds. Although in this example the image 950 is generated by the precision crop load management system, embodiments are not so limited, and the precision crop load management system may obtain data regarding the buds from the image 900 without generating the image 950.

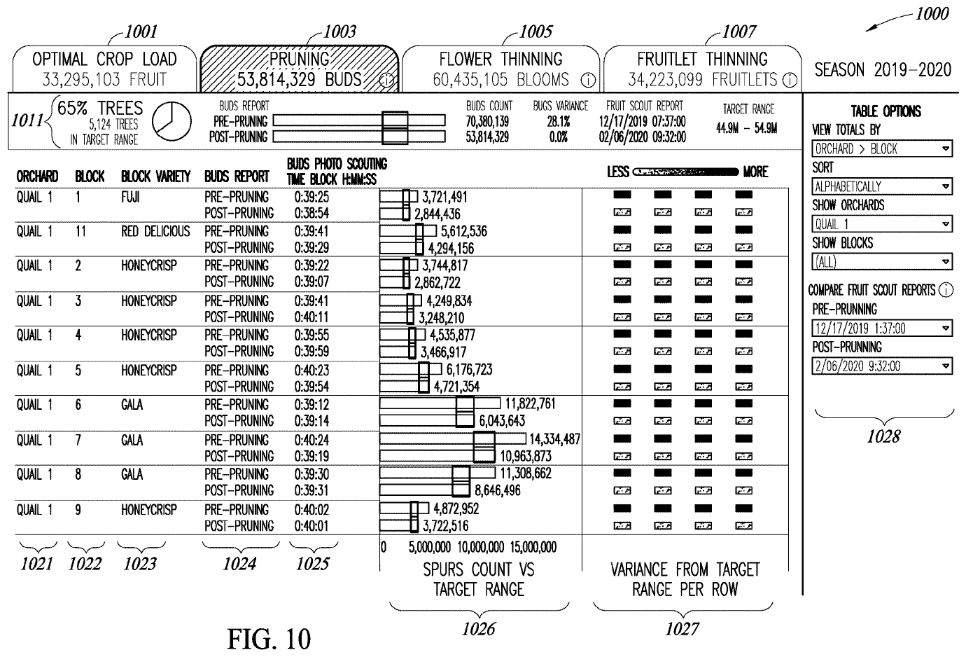

FIG. 10 is a sample dashboard 1000 which may be generated by a precision crop load management system, according to various embodiments described herein. The dashboard 1000 includes a crop load tab 1001, a pruning tab 1003, a flower thinning tab 1005, a fruitlet thinning tab 1007, a total bud count section 1011, an orchard column 1021, a block column 1022, block variety column 1023, a buds report column 1024, a buds photo scouting column 1025, a spurs count versus target range column 1026, a variance from target range per row column 1027, and a table options section 1028. The crop load tab 1001, pruning tab 1003, flower thinning tab 1005, fruitlet thinning tab 1007, orchard column 1021, block column 1022, block variety column 1023, buds photo scouting column 1025, and table options section 1028 are similar to the crop load tab 701, pruning tab 703, flower thinning tab 705, fruitlet thinning tab 707, orchard column 721, block column 722, block variety column 723, photo scouting column 724 and table options section 728 respectively. The pruning tab 1003 indicates the total number of buds growing on crops associated with the precision crop load management system. The total bud count section 1011 includes information indicating the number of trees which are in the target crop load range, the number of buds before and after pruning, the variance between numbers of buds, and the bud target range. The bud target range indicates a target range of the amount of buds growing on crops, and may be determined based on the one or more growth goals.

The buds report column 1024 indicates whether the data included in the dashboard 1000 was obtained before pruning or after pruning. The spurs count versus target range column 1026 indicates the total bud count for a block indicated in the block column 1022 before pruning, the total bud count after pruning, and a bud target range for the block. The target range in the spurs count versus target range column 1026 is indicated by a box which encases a portion of the bar graphs included in the target range column 1026. The variance from target range per row column 1027 includes data indicating a measure of the distance of each row of crops included in a block identified by the block column 1022 from the bud target range. In the variance from target range per row column 1027, the distance is indicated based on a scale which depicts crops which have a smaller variance (i.e. which are closer to the target range of buds) as lighter colored, or less shaded, in than crops which have a greater variance.

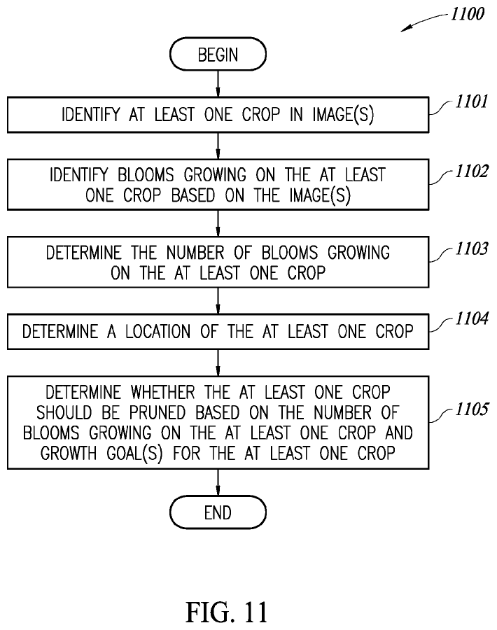

FIG. 11 is a flow diagram depicting a process 1100 for determining whether at least one crop should be pruned based on the number of blooms growing on the at least one crop, according to various embodiments described herein. The process 1100 may be performed by precision crop load management system, such as the precision crop load management system 101 described above in connection with FIG. 2. The process 1100 begins, after a start block at act 1101, where the precision crop load management system identifies at least one crop in one or more images. In some embodiments, act 1101 is performed in a similar manner to act 801.

The process 1100 proceeds to act 1102, where the precision crop load management system identifies blooms growing on the at least one crop based on the one or more images. In some embodiments, the precision crop load management system may identify the blooms growing on the crop at act 1102 in a similar manner to identifying the buds growing on the at least one crop as described above in connection with act 802.

The process 1100 continues to act 1103, where the precision crop load management system determines a number of blooms growing on the at least one crop. In some embodiments, the precision crop load management system may determine the number of blooms at act 1103 in a similar manner to determining the number of buds as described above in connection with act 803.

The process 1100 proceeds to act 1104, where the precision crop load management system determines a location of the at least one crop. In some embodiments, act 1104 is performed in a similar manner to act 804.

The process 1100 proceeds to act 1105, where the precision crop load management system determines whether the at least one crop should be pruned based on the number of blooms growing on the at least one crop and the growth goals for the at least one crop. In some embodiments, the precision crop load management system may determine whether the at least one crop should be pruned based on the number of blooms growing on the at least one crop at act 1105 in a similar manner to determining whether the at least one crop should be pruned based on the number of buds growing on the at least one crop as described above in connection with act 805.

After act 1105 the process 1100 ends. In some embodiments, the precision crop load management system generates a flower thinning dashboard similar to the dashboard 1000.

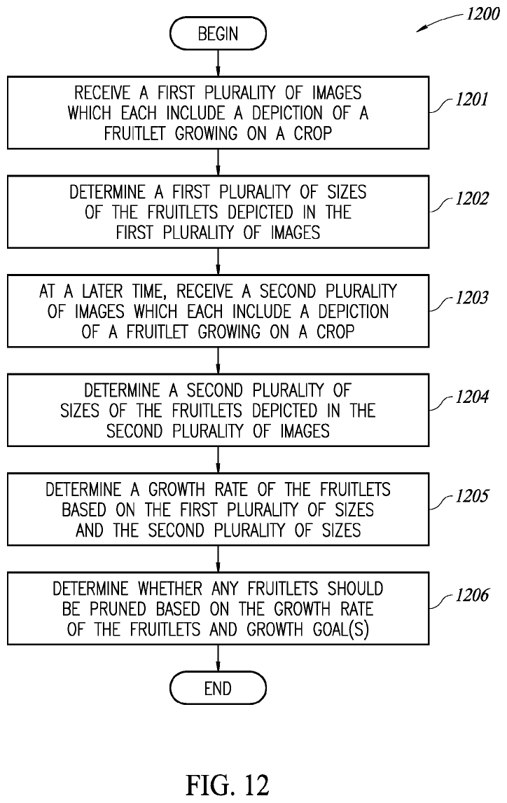

FIG. 12 is a flow diagram of a process 1200 for determining whether fruitlets should be pruned, according to various embodiments described herein. The process 1200 may be performed by a precision crop load management system, such as the precision crop load management system 101 described above in connection with FIG. 2. The process 1200 begins, after a start block, at act 1201, where the precision crop load management system receives a first plurality of images which each include a depiction of a fruitlet growing on a crop. In some embodiments, act 1201 is performed in a similar manner to act 302 described above in connection with FIG. 3.

The process 1200 proceeds to act 1202, where the precision crop load management system determines a first plurality of sizes of the fruitlets depicted in the first plurality of images. In some embodiments, the precision crop load management system determines the size of each fruitlet in a similar manner to determining the trunk size in act 502 described above in connection with FIG. 5. In some embodiments, at act 1202, the precision crop load management system identifies one or more fruitlets growing on the at least one crop in a similar manner to the identification of blooms growing on the at least one crop at act 1102, described above in connection with FIG. 11.

The process 1200 proceeds to act 1203, where the precision crop load management system receives a second plurality of images which each include a depiction of a fruitlet growing on a crop at a later time. The process 1200 proceeds to act 1204, where the precision crop load management system determines a second plurality of sizes of the fruitlets depicted in the second plurality of images. The precision crop load management system may perform acts 1203 and 1204 in a similar manner to acts 1201 and 1202 respectively. The fruitlets depicted in the second plurality of images may be the same fruitlets depicted in the first plurality of images, different fruitlets than those depicted in the first plurality of images, or some combination thereof.

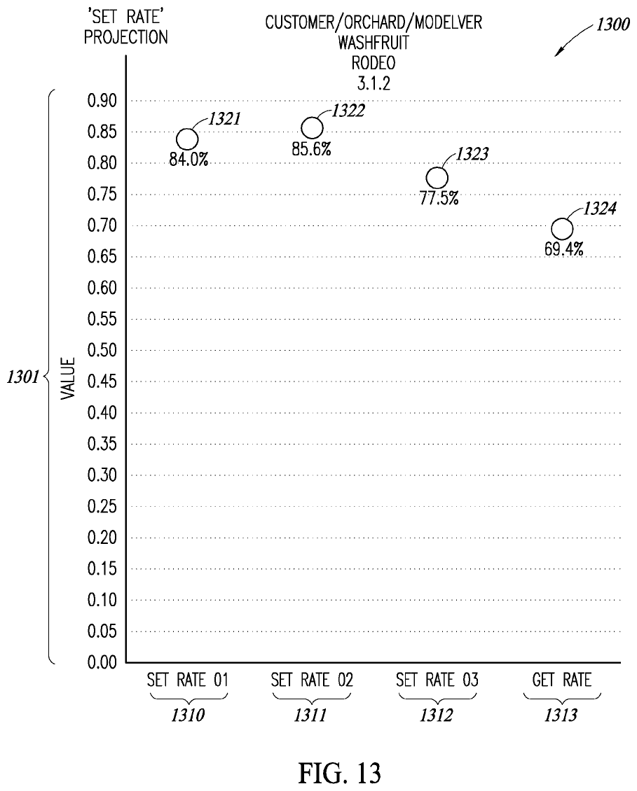

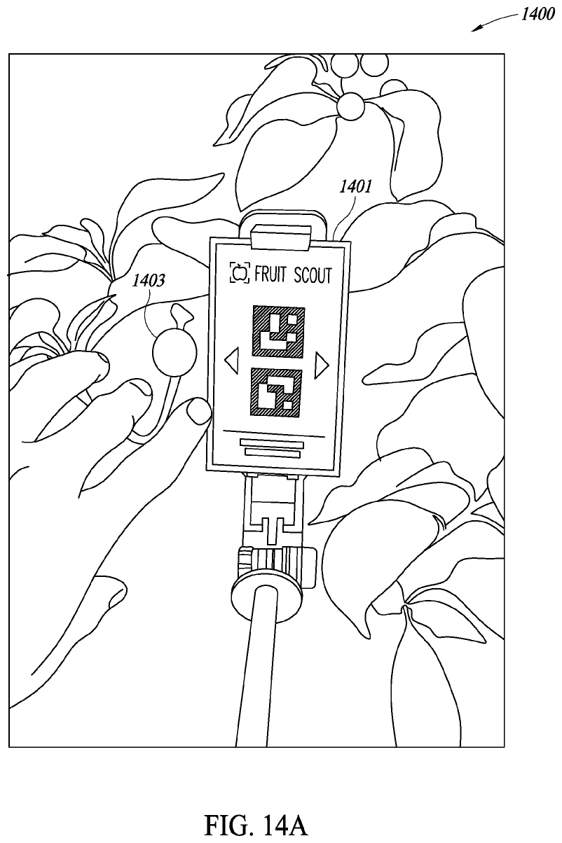

The process 1200 proceeds to act 1205, where the precision crop load management system determines a growth rate of the fruitlets based on the first plurality of sizes and the second plurality of sizes. In some embodiments, the precision crop load management system determines the growth rate by applying the first plurality of sizes and the second plurality of sizes to an artificial intelligence or machine learning model trained to determine a growth rate of fruitlets based on at least a first plurality of sizes and a second plurality of sizes. In some embodiments, the precision crop load management system applies statistical analysis to the first plurality of sizes and second plurality of sizes to determine the growth rate of fruitlets. In some embodiments, the precision crop load management system uses a fruitlet growth model, such as the fruitlet growth model described below in connection with FIG. 13, to determine the growth rate of the fruitlets. In some embodiments, the precision crop load management system receives one or more images in addition to the first and second plurality of images, and determines additional sizes of fruitlets to determine the growth rate. The precision crop load management system may receive additional images periodically and adjust the growth rate of the fruitlets based on the periodically received images.

The process 1200 proceeds to act 1206, where the precision crop load management system determines whether any fruitlets should be pruned based on the growth rate of the fruitlets and one or more growth goals. The precision crop load management system may determine whether any fruitlets should be pruned in act 1206 in a similar manner to determining whether any blooms should be pruned as described above in connection with act 1105.

After act 1206, the process 1200 ends. In some embodiments, during the process 1200, the precision crop load management system determines the number of fruitlets growing on a crop in a similar manner to determining the number of buds growing on the crop at act 803, described above in connection with FIG. 8.

FIG. 13 is a display diagram of a graph 1300 which is used as part of a fruitlet growth model, according to various embodiments described herein. The y-axis 1301 of the graph 1300 is the “set rate” value which represents the change in the growth of the fruitlets since the last measurement. The x-axis of the graph represents different times that the set rate value was obtained, as indicated by the set rates 1310-1312. The set rate values 1321-1323 correspond to set rates 1310-1312 respectively, and each indicate the set rate at different times. The get rate 1313 is a prediction of the growth rate, and is indicated by the get rate value 1324. Each set rate may be determined based on the change in the size of fruitlets over time, which may be obtained by comparing the fruitlet size at a first time to the fruitlet size at a second time. The precision crop load management system uses these set rates to determine a growth rate of all of the fruitlets managed by the precision crop load management system. In some embodiments, the precision crop load management system

In an example embodiment, the precision crop load management system receives images at a first time of a plurality of fruitlets, and processes each image to obtain a first size for each fruitlet. The plurality of fruitlets may include a plurality of fruitlets from a plurality of crops, such that the sample size of the fruitlets is sufficient to represent the average size of each fruitlet when aggregated. The first sizes of each fruitlet are aggregated, such as by summing, calculating a mean, median, or mode, or other methods of aggregating data. At a second time, which may be days later, the precision crop load management system receives additional images of a plurality of fruitlets and processes each additional image to obtain a second size for each fruitlet. The second sizes are aggregated in a similar manner to the first sizes. The precision crop load management system predicts a growth rate of the fruitlets based on the first aggregated sizes and the second aggregated sizes. Furthermore, because of the sample size of the fruitlets, the same fruitlets do not have to be measured at the first and second times. The sample size of the fruitlets may vary based on the optimal crop load, growth goals, or other factors which may affect a sample size. Thus, unlike conventional methods of determining the growth rate of fruitlets, computing or other resources are not required to be used to determine whether the same fruitlets are being measured at each measurement time. The sample size of the fruitlets additionally allows the precision crop load management system to accurately determine the growth rate of fruitlets with data obtained from two measurements performed at different times, in contrast to conventional systems which require additional and more frequent measurements.

In some embodiments, the sample size may be changed by the precision crop load management system or by a user based on historical fruitlet growth rate data, the growth goals, the optimal crop load, or the accuracy of the growth rate as additional images are obtained at future times. For example, the growth rate may be determined to be 0.1 inches per day with a sample size of 100 fruitlets per orchard after measuring the fruitlets at two different times, while the actual growth rate may be measured to be 0.15 inches per day after measuring the fruitlets at a third time. The precision crop load management system may determine that the sample size should be increased to 200 fruitlets per orchard, in order to ensure that the aggregated sizes of the sampled fruitlets accurately reflect the aggregated size of all of the fruitlets.

In some embodiments, the precision crop load management system uses historical data in addition to the fruitlet sizes to determine the growth rate of the fruitlets. The historical data may include historical growth rates of fruitlets as well as other crop data related to the crops upon which the fruitlets are growing.

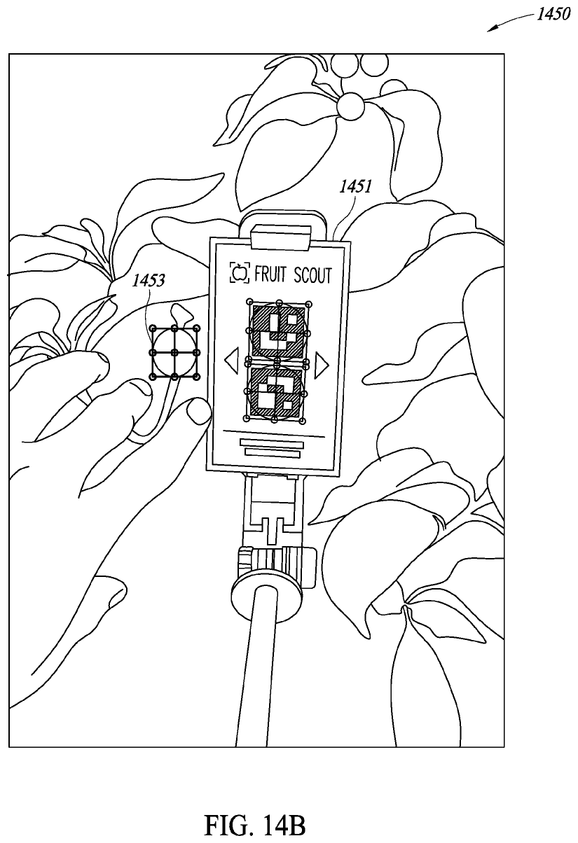

FIG. 14A is a display diagram depicting an example image 1400 of a fruitlet measurement image received by the precision crop load management system, according to various embodiments described herein. The image 1400 includes a scale 1401 and a fruitlet 1403. The image 1400 is an example of an image which includes at least one aspect of a crop, where the at least one aspect of the crop is a fruitlet, which may be received by a precision crop load management system, such as the precision crop load management system 101. The scale 1401 is a scale which may be used by the precision crop load management system to determine a size of at least one aspect of the crop, such as the trunk of the fruitlet 1403.

FIG. 14B is a display diagram depicting an example image 1450 of a fruitlet measurement image after a precision crop load management system has processed the image, according to various embodiments described herein. The image 1450 includes a scale 1451 and a fruitlet 1453. The image 1450 is an example of a result of the processing performed by the precision crop load management system to obtain a size of a fruitlet growing on a crop. In some embodiments, the precision crop load management system may obtain data from processing the image 1400 without generating the image 1450. As can be seen in the image 1450, the precision crop load management system has identified the scale 1451 and the fruitlet 1453 of the crop, as shown by the boxes depicted on the scale 1451 and the fruitlet 1453. The precision crop load management system compares the scale 1451 to the fruitlet 1453 to obtain a measurement of the fruitlet 1453. The measurement of the fruitlet may be any measurement used to identify a geometric property of the fruitlet, such as an area, length, width, circumference, diameter, volume, or other geometric properties. In some embodiments, the precision crop load management system obtains multiple measurements of the fruitlet. Although in this example the image 1450 is generated by the precision crop load management system, embodiments are not so limited, and the precision crop load management system may obtain data regarding the fruitlet from the image 1400 without generating the image 1450.

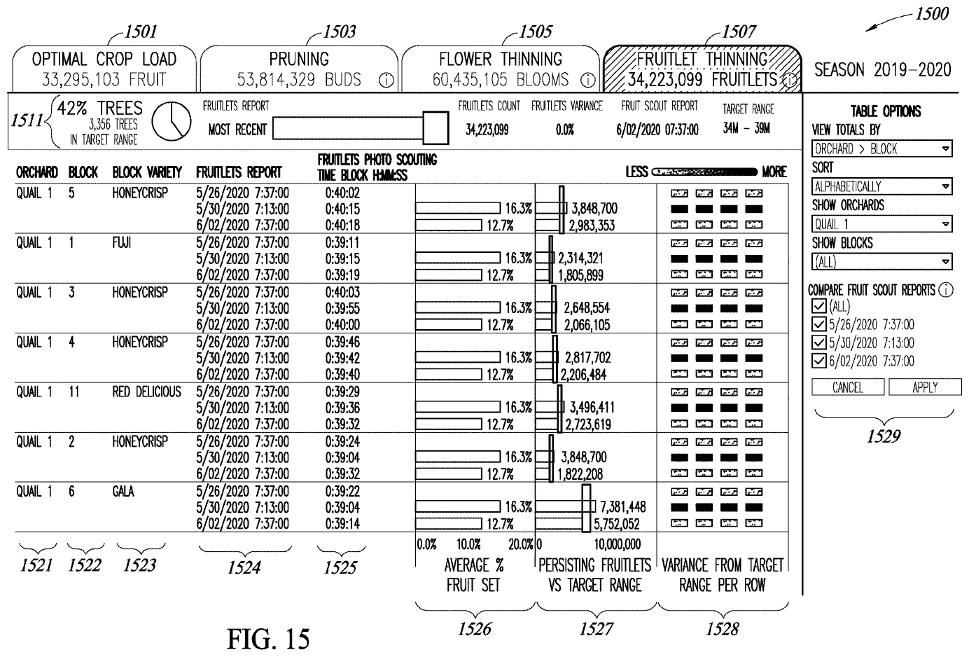

FIG. 15 is a sample dashboard 1500 which may be generated by a precision crop load management system, according to various embodiments described herein. The dashboard 1500 includes a crop load tab 1501, a pruning tab 1503, a flower thinning tab 1505, a fruitlet thinning tab 1507, a total fruitlet count section 1511, an orchard column 1521, a block column 1522, block variety column 1523, a fruitlet report column 1524, a photo scouting column 1525, a fruit set column 1526, a persisting fruitlets versus target range column 1527, a variance from target range per row column 1528, and a table options section 1529. The crop load tab 1501, pruning tab 1503, flower thinning tab 1505, fruitlet thinning tab 1507, orchard column 1521, block column 1522, block variety column 1523, photo scouting column 1525, and table options section 1529 are similar to the crop load tab 701, pruning tab 703, flower thinning tab 705, fruitlet thinning tab 707, orchard column 721, block column 722, block variety column 723, photo scouting column 724, and table options section 728 respectively. The fruitlet tab 1503 indicates the total number of fruitlets growing on crops associated with the precision crop load management system. The total fruitlet count section 1511 includes information indicating the number of trees which are in the target crop load range, the number of fruitlets growing on the trees according to the most recent data, the variance between the number of fruitlets, the date of the last fruitlet scouting report, and the fruitlet target range. The fruitlet target range indicates a target range of the amount of fruitlets growing on crops, and may be determined based on the one or more growth goals.

The fruitlet report column 1524 indicates when the data displayed in the dashboard 1500 was obtained. The fruit set column 1526 indicates percentage of fruitlets that will, or are predicted to, survive. In some embodiments, the system determines the percentage of fruitlets that will, or are predicted to, survive based on a growth rate of fruitlets and any pruning methods used for the fruitlets. For example, fruitlets with a faster growth rate are more likely to survive when a chemical thinner is applied, while fruitlets with a slower growth rate are less likely to survive a chemical thinner.

The persisting fruitlets vs target range column 1527 includes data indicating the amount of fruitlets which have persisted in growing as compared to the target range of the fruitlets. The target range of the fruitlets is indicated by a box which encases a portion of the bar graphs included in the column 1527. The variance from target range per row column 1528 indicates a measure of how far each row included in a block is from the target range of fruitlets. In the variance from target range per row column 1528, the measure is indicated via a scale that depicts crops that are closer to the target range of fruitlets as lighter colored, or less shaded in, than rows that are further from the target range of fruitlets.

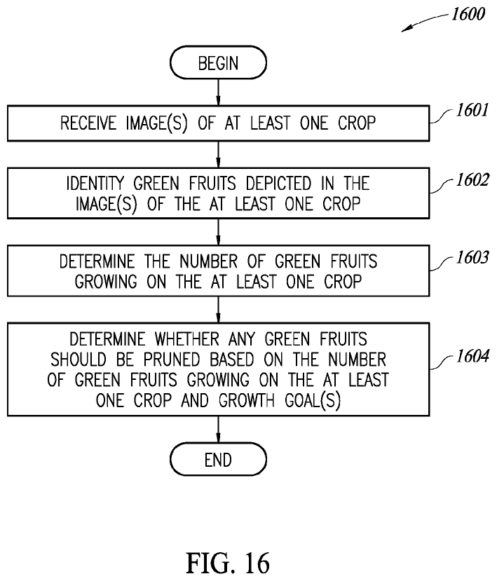

FIG. 16 is a flow diagram depicting a process 1600 for determining whether green fruits should be pruned, according to various embodiments described herein. A green fruit may refer to the growth stage of the crop after the crop is a fruitlet, but before the crop is ready for picking. Although the process 1600 is used to identify whether green fruits should be pruned, a similar process may be performed for other stages of a crop's lifecycle, such as determining whether the crops are ripe, determining whether the crops are ready to be picked, or other stages of a crops lifecycle. The process 1600 may be performed by a precision crop load management system, such as the precision crop load management system 101 described above in connection with FIG. 2.

The process 1600 begins, after a start block, at act 1601, where the precision crop load management system receives one or more images of at least one crop, the one or more images including a depiction of at least one green fruit growing on a crop. In some embodiments, act 1601 may be performed in a similar manner to act 302.

The process 1600 continues to act 1602, where the precision crop load management system identifies green fruits depicted in the one or more images of the at least one crop. In some embodiments, identifying green fruits at act 1602 is performed in a similar manner to identifying blooms growing on the at least one crop at act 1102, described above in connection with FIG. 11.

The process 1600 continues to act 1603, where the precision crop load management system determines the number of green fruits growing on the at least one crop. In some embodiments, determining the number of green fruits growing on the at least one crop is performed in a similar manner to determining the number of buds growing on the at least one crops at act 803, described above in connection with FIG. 8.

The process 1600 continues to act 1604, where the precision crop load management system determines whether any green fruits should be pruned based on the number of green fruits growing on the at least one crop and the growth goals. In some embodiments, determining whether any green fruits should be pruned is performed in a similar manner to determining which buds should be pruned in act 805, as described above in connection with FIG. 8.

After act 1604, the process 1600 ends.

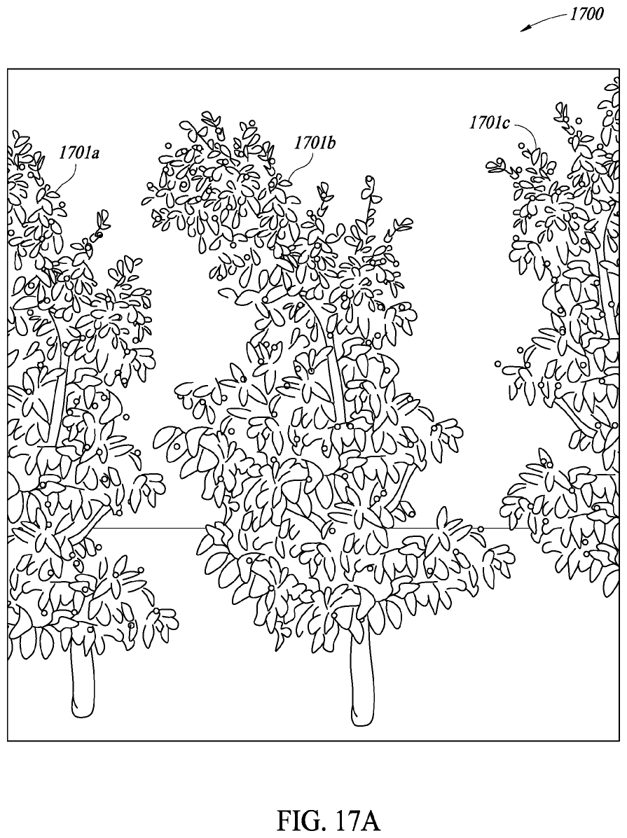

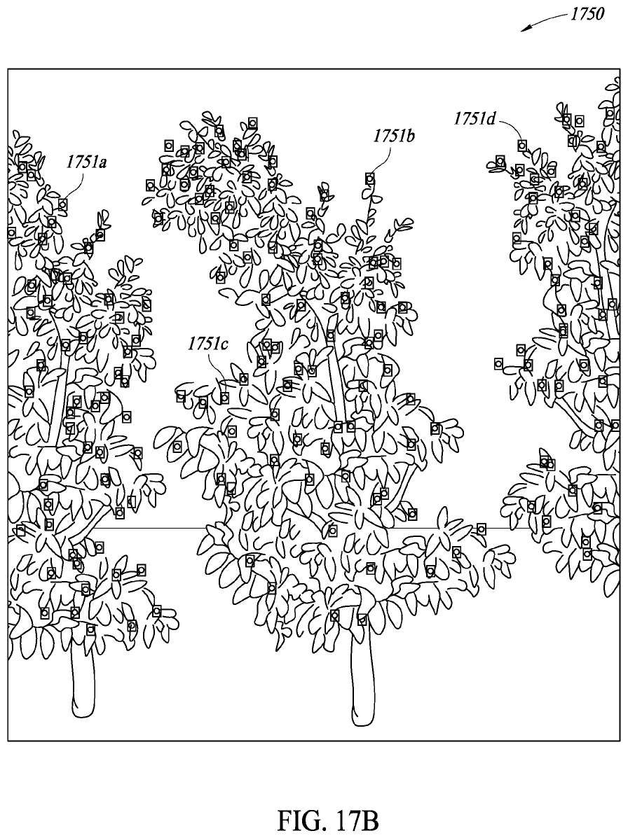

FIG. 17A is a display diagram depicting an example image 1700 of crops bearing green fruit received by the precision crop load management system, according to various embodiments described herein. The image 1700 includes crops 1701a, 1701b, and 1701c. The image 1700 is an example of an image which includes at least one aspect of a crop, where the at least one aspect of the crop is a green fruit, and which may be received by a precision crop load management system, such as the precision crop load management system 101.

FIG. 17B is a display diagram depicting an example image 1750 of crops bearing green fruit after a precision crop load management system has processed the image, according to various embodiments described herein. The image 1750 includes green fruits 1751a, 1751b, 1751c, and 1751d (collectively “green fruits 1751”). The image 1750 is an example of a result of the processing performed by a precision crop load management system to determine the number of green fruits growing on a crop. In some embodiments, the precision crop load management system may obtain data from processing the image 1700 without generating the image 1750. As can be seen in the image 1750, the precision crop load management system has identified the green fruits visible on the crop, such as green fruits 1751, as indicated by the boxes enveloping the green fruits depicted in the image 1750. In some embodiments, the precision crop load management system determines the number of green fruits growing on the crop in a similar manner to determining the number of buds growing on the crop, as described above in connection with FIGS. 8-10. In some embodiments, the precision crop load management system obtains measurements of the green fruits in a similar manner to obtaining the measurements of the fruitlets, as described above in connection with FIGS. 12-15. Although in this example the image 1750 is generated by the precision crop load management system, embodiments are not so limited, and the precision crop load management system may obtain data regarding the green fruits from the image 1700 without generating the image 1750.

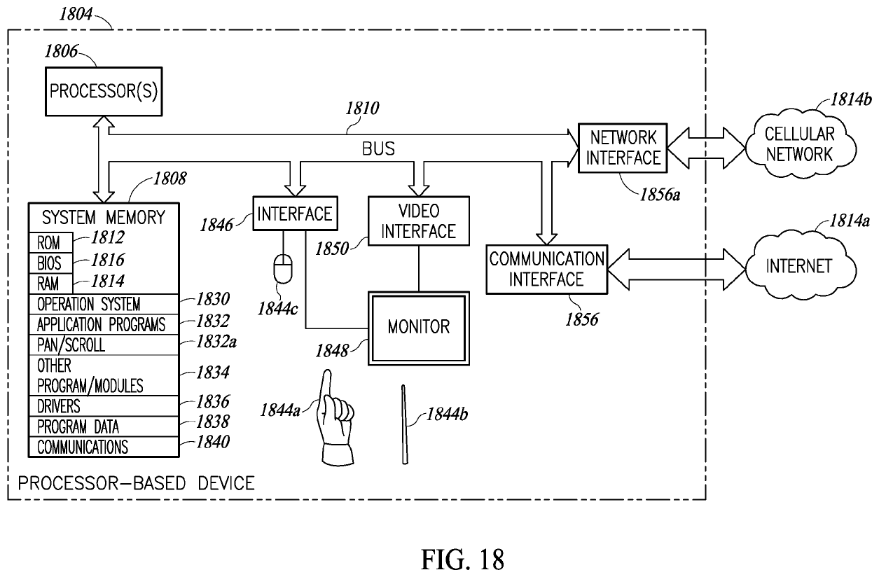

FIG. 18 shows a processor-based device 1804 suitable for implementing the various functionality described herein. At least a portion of the operations, functionality, processes, and data described above in connection with the precision crop load management system may be used, stored, executed, etc., by the processor-based device 1804. Although not required, some portion of the implementations will be described in the general context of processor-executable instructions or logic, such as program application modules, objects, or macros being executed by one or more processors. Those skilled in the relevant art will appreciate that the described implementations, as well as other implementations, can be practiced with various processor-based system configurations, including handheld devices, such as smartphones and tablet computers, wearable devices, multiprocessor systems, microprocessor-based or programmable consumer electronics, personal computers (“PCs”), network PCs, minicomputers, mainframe computers, and the like.

The processor-based device 1804 may include one or more processors 1806, a system memory 1808 and a system bus 1810 that couples various system components including the system memory 1808 to the processor(s) 1806. The processor-based device 1804 will at times be referred to in the singular herein, but this is not intended to limit the implementations to a single system, since in certain implementations, there will be more than one system or other networked computing device involved. Non-limiting examples of commercially available systems include, but are not limited to, ARM processors from a variety of manufactures, Core microprocessors from Intel Corporation, U.S.A., PowerPC microprocessor from IBM, Sparc microprocessors from Sun Microsystems, Inc., PA-RISC series microprocessors from Hewlett-Packard Company, 68xxx series microprocessors from Motorola Corporation.

The processor(s) 1806 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 18 are of conventional design. As a result, such blocks need not be described in further detail herein, as they will be understood by those skilled in the relevant art.

The system bus 1810 can employ any known bus structures or architectures, including a memory bus with memory controller, a peripheral bus, and a local bus. The system memory 1808 includes read-only memory (“ROM”) 1812 and random access memory (“RAM”) 1814. A basic input/output system (“BIOS”) 1816, which can form part of the ROM 1812, contains basic routines that help transfer information between elements within processor-based device 1804, such as during start-up. Some implementations may employ separate buses for data, instructions and power.

The processor-based device 1804 may also include one or more solid state memories, for instance Flash memory or solid state drive (SSD) 1818, which provides nonvolatile storage of computer-readable instructions, data structures, program modules and other data for the processor-based device 1804. Although not depicted, the processor-based device 1804 can employ other nontransitory computer-or processor-readable media, for example a hard disk drive, an optical disk drive, or memory card media drive.

Program modules can be stored in the system memory 1808, such as an operating system 1830, one or more application programs 1832, other programs or modules 1834, drivers 1836 and program data 1838.

The application programs 1832 may, for example, include panning/scrolling 1832a. Such panning/scrolling logic may include, but is not limited to logic that determines when and/or where a pointer (e.g., finger, stylus, cursor) enters a user interface element that includes a region having a central portion and at least one margin. Such panning/scrolling logic may include, but is not limited to logic that determines a direction and a rate at which at least one element of the user interface element should appear to move, and causes updating of a display to cause the at least one element to appear to move in the determined direction at the determined rate. The panning/scrolling logic 1832a may, for example, be stored as one or more executable instructions. The panning/scrolling logic 1832a may include processor and/or machine executable logic or instructions to generate user interface objects using data that characterizes movement of a pointer, for example data from a touch-sensitive display or from a computer mouse or trackball, or other user interface device.

The system memory 1808 may also include communications programs 1840, for example a server and/or a Web client or browser for permitting the processor-based device 1804 to access and exchange data with other systems such as user computing systems, Web sites on the Internet, corporate intranets, or other networks as described below. The communications programs 1840 in the depicted implementation is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While shown in FIG. 18 as being stored in the system memory 1808, the operating system 1830, application programs 1832, other programs/modules 1834, drivers 1836, program data 1838 and server and/or communications programs 1840 can be stored on any other of a large variety of nontransitory processor-readable media (e.g., hard disk drive, optical disk drive, SSD and/or flash memory).

A user may enter commands and information via a pointer, for example through input devices such as a touch screen 1848 via a finger 1844a, stylus 1844b, or via a computer mouse or trackball 1844c which controls a cursor. Other input devices can include a microphone, joystick, game pad, tablet, scanner, biometric scanning device, etc. These and other input devices (i.e., “I/O devices”) are connected to the processor(s) 1806 through an interface 1846 such as touch-screen controller and/or a universal serial bus (“USB”) interface that couples user input to the system bus 1810, although other interfaces such as a parallel port, a game port or a wireless interface or a serial port may be used. The touch screen 1848 can be coupled to the system bus 1810 via a video interface 1850, such as a video adapter to receive image data or image information for display via the touch screen 1848. Although not shown, the processor-based device 1804 can include other output devices, such as speakers, vibrator, haptic actuator, etc.

The processor-based device 1804 may operate in a networked environment using one or more of the logical connections to communicate with one or more remote computers, servers and/or devices via one or more communications channels, for example, one or more networks 1814a, 1814b. These logical connections may facilitate any known method of permitting computers to communicate, such as through one or more LANs and/or WANs, such as the Internet, and/or cellular communications networks. Such networking environments are well known in wired and wireless enterprise-wide computer networks, intranets, extranets, the Internet, and other types of communication networks including telecommunications networks, cellular networks, paging networks, and other mobile networks.

When used in a networking environment, the processor-based device 1804 may include one or more wired or wireless communications interfaces 1814a, 1814b (e.g., cellular radios, WI-FI radios, Bluetooth radios) for establishing communications over the network, for instance the Internet 1814a or cellular network.

In a networked environment, program modules, application programs, or data, or portions thereof, can be stored in a server computing system (not shown). Those skilled in the relevant art will recognize that the network connections shown in FIG. 18 are only some examples of ways of establishing communications between computers, and other connections may be used, including wirelessly.

For convenience, the processor(s) 1806, system memory 1808, network and communications interfaces 1814a, 1814b are illustrated as communicably coupled to each other via the system bus 1810, thereby providing connectivity between the above-described components. In alternative implementations of the processor-based device 1804, the above-described components may be communicably coupled in a different manner than illustrated in FIG. 18. For example, one or more of the above-described components may be directly coupled to other components, or may be coupled to each other, via intermediary components (not shown). In some implementations, system bus 1810 is omitted and the components are coupled directly to each other using suitable connections.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMS, digital tape, and computer memory.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

This application claims the benefit of priority to U.S. Provisional Application No. 63/486,896, filed Feb. 24, 2023, which is hereby incorporated by reference in its entirety.

1. A method of operating a computer system, comprising:
determining one or more target metrics for at least one crop;
receiving a first set of one or more images, each image of the first set of one or more images including a depiction of at least one aspect of the at least one crop;
identifying one or more aspects of the at least one crop based on the first set of one or more images;
generating at least one indicator regarding the growth of the at least one crop based on the identified one or more aspects of the at least one crop;
determining whether the one or more target metrics have been met based on the at least one indicator regarding the growth of the at least one crop and the one or more target metrics; and
generating one or more actions to meet the one or more target metrics based on the determination of whether the one or more target metrics have been met.

2. The method of claim 1, wherein the identifying one or more aspects of the at least one crop further comprises:
determining a size of the one or more aspects of the at least one crop based on the first set of one or more images.

3. The method of claim 2, wherein the determined size is a trunk size, canopy size, plant size, or tree size, and wherein generating at least one indicator regarding the growth of the at least one crop further comprises:
receiving historical data, the historical data comprising historical crop size data and historical crop yield data for crops that have grown within a selected geographic area; and
determining an optimal crop load for the at least one crop based on the determined size and the historical data.

4. The method of claim 3, wherein determining the target metrics for at least one crop further comprises:
generating at least one target metric of the one or more target metrics based on the optimal crop load.

5. The method of claim 1, wherein the at least one aspect of the at least one crop comprises fruitlets of the at least one crop, and wherein generating at least one indicator regarding the growth of the at least one crop further comprises:
determining a first size of a first plurality of fruitlets of the at least one crop based on the first set of one or more images;
receiving a second set of one or more images;
determining a second size of a second plurality of fruitlets of the at least one crop based on the second set of one or more images; and
determining a growth rate of the fruitlets of the at least one crop based on at least the first size of the first plurality of fruitlets and the second size of the second plurality of fruitlets.

6. The method of claim 1, wherein the at least one aspect of the at least one crop grows on the at least one crop, and wherein generating at least one indicator regarding the growth of the at least one crop further comprises:
determining a number of the at least one aspect depicted in the first set of one or more images; and
generating a prediction of the number of the at least one aspect which have grown on the at least one crop based on the determined number of the at least one aspect depicted in the first set of one or more images.

7. The method of claim 6, wherein generating the prediction of the number of the at least one aspect further comprises:
at a time after the first set of one or more images are received, receiving a second set of one or more images, each image of the second set of one or more images including a depiction of at least one aspect of the at least one crop;
determining a second number of the at least one aspect depicted in the second set of one or more images;
determining a change in the number of the at least one aspect which have grown on the at least one crop based on the number of the at least one aspect depicted in the first set of one or more images and the second number of the at least one aspect depicted in the second set of one or more images; and
generating the prediction of the number of the at least one aspect which have grown on the at least one crop based on at least the determined change in the number of the at least one aspect which have grown on the at least one crop.

8. The method of claim 6, wherein generating the prediction of the number of the at least one aspect further comprises:
identifying at least one other aspect of the at least one crop; and
applying the number of the at least one aspect depicted in the first set of one or more images and the at least one other aspect to a machine learning model configured to generate a prediction of the number of the at least one aspect growing on the crop based on an number of the at least one aspect and at least one other aspect of the at least one crop.

9. The method of claim 6, wherein the at least one aspect that grows on the at least one crop is at least one of:
a bud;
a bloom;
a fruitlet; or
a fruit.

10. The method of claim 1, wherein the method further comprises:
generating one or more dashboards based on the one or more target metrics and the at least one indicator regarding the growth of the at least one crop.

11. The method of claim 1, wherein target metric comprise one or more of:
a crop count;
a bud count;
a bloom count;
a fruitlet count;
a fruit count;
a fruit size; or
an orchard count.

12. The method of claim 1, wherein the actions comprise one or more of:
pruning branches;
bloom thinning;
fruitlet thinning;
green fruit thinning; or
continuing management of the crop without changes.

13. A system comprising:
a camera;
at least one processor; and
at least one memory coupled to the at least one processor, the at least one memory having computer-executable instructions stored thereon that, when executed by the at least one processor, cause the system to:
generate, based on user input, one or more target metrics of at least one crop;
receive, via the camera, a first set of one or more images of at least one aspect of the at least one crop;
identify one or more aspects of the at least one crop based on the first set of one or more images;
generate at least one indicator regarding the growth of the at least one crop based on the one or more aspects of the at least one crop;
determine whether the one or more target metrics have been met based on the at least one indicator regarding the growth of the at least one crop and the one or more target metrics; and
generate one or more actions to meet the one or more target metrics based on the determination.

14. The system of claim 13, wherein to cause the at least one processor to identify one or more aspects of the at least one crop, the computer-executable instructions further cause the system to:
identify one or more scales within the first set of one or more images; and
determine a size of the aspect of the at least one crop based on the first set of one or more images and the one or more scales.

15. The system of claim 13, wherein to generate the one or more actions to meet the one or more target metrics, the computer-executable instructions further cause the system to:
determine, based on the one or more aspects of the at least one crop and the at least one indicator, a growth stage of the at least one crop;
generate the one or more actions based on the prediction and the growth stage of the at least one crop; and
present the one or more actions to a user.

16. The system of claim 13, the computer-executable instructions further cause the system to:
determine, based on the one or more aspects of the at least one crop and the at least one indicator, a growth stage of the at least one crop;
generate one or more dashboards based on the one or more target metrics, the at least one indicator regarding the growth of the at least one crop; and
present the one or more dashboards to a user.

17. A nontransitory computer-readable storage medium that stores at least one of instructions or data, the instructions or data, when executed by at least one processor, cause the at least one processor to:
receive one or more target metrics of at least one crop;
receive a first set of one or more images;
identify one or more aspects of the at least one crop based on the first set of one or more images;
generate at least one indicator regarding the growth of the at least one crop based on the one or more aspects of the at least one crop; and
determine whether the one or more target metrics will be met based on the at least one indicator.

18. The nontransitory computer-readable storage medium of claim 17, wherein the instructions or data further cause the at least one processor to:
generate one or more actions to meet the one or more target metrics based on the prediction.

19. The nontransitory computer-readable storage medium of claim 17, wherein to identify the one or more aspects of the at least one crop the instructions or data further cause the at least one processor to:
determine a size of the one or more aspects of the at least one crop based on the first set of one or more images.

20. The nontransitory computer-readable storage medium of claim 19, wherein the determined size of the one or more aspects of the at least one crop comprises a trunk size and wherein to generate at least one indicator regarding the growth of the at least one crop the instructions or data further cause the at least one processor to:
receive historical data comprising historical crop size data and historical crop yield data for crops that have grown within a selected geographic area; and
determining an optimal crop load for the at least one crop based on the determined size and the historical data.

21. The nontransitory computer-readable storage medium of claim 20, wherein the instructions or data further cause the at least one processor to:
generate at least one target metric based on the optimal crop load.

22. The nontransitory computer-readable storage medium of claim 17, wherein to generate the at least one indicator the instructions or data further cause the at least one processor to:
identify first one or more fruitlets growing on the at least one crop based on the first set of one or more images;
determine first sizes of the first one or more fruitlets based on the first set of one or more images;
receive a second set of one or more images;
identify second one or more fruitlets growing on the at least one crop based on the first set of one or more images, the second one or more fruitlets including at least a portion of the first one or more fruitlets;
determine second sizes of the second one or more fruitlets based on the second set of one or more images; and
determine a growth rate of the fruitlets based on at least the first sizes of the first one or more fruitlets and the second sizes of the second plurality of fruitlets.

23. The nontransitory computer-readable storage medium of claim 17, wherein at least one aspect of the one or more aspects grows on the at least one crop, and wherein to generate the at least one indicator the instructions or data further cause the at least one processor to:
identify one or more of the at least one aspect growing on the at least one crop based on the first set of one or more images; and
generate a prediction of a number of the at least one aspect growing on the at least one crop based on the identified one or more of the at least one aspect.

24. The nontransitory computer-readable storage medium of claim 23, wherein the at least one aspect that grows on the at least one crop is at least one of:
a bud;
a bloom;
a fruitlet; or
a fruit.

25. One or more storage devices collectively storing a crop load management data structure, the data structure comprising:
information indicating a crop;
information indicating an optimal crop load for the crop;
information indicating one or more images of the crop;
information indicating a number of at least one aspect of the crop; and
information indicating one or more target metrics,
such that the information indicating the one or more images of the crop are usable to determine the number of at least one aspect of the crop, and
such that the information indicating the optimal crop load, the information indicating the number of at least one aspect of the crop, and the information indicating the one or more target metrics are usable to generate one or more actions to meet the one or more target metrics.

26. The one or more storage devices of claim 25 wherein at least one image of the one or more images of the crop include a depiction of other crops, and wherein the crop load management data structure further comprises:
information indicating a crop identification model, such that the crop identification model is usable to distinguish the crop from the other crops based on the at least one image.

27. The one or more storage devices of claim 26 wherein the crop identification model comprises at least one of:
a first model configured to identify a first aspect of crops and to divide the at least one image based on at least one identified first aspect of one or more crops included in the at least one image;
a second model configured to identify a second aspect of each crop depicted in the at least one image, a plurality of third aspects of crops, and to determine a distance of the plurality of third aspects from the second aspect of each crop; and
a third model trained to identify one or more crops in an image.

28. The one or more storage devices of claim 27 wherein the crop load management data structure further comprises:
a weight applied to each model included in the crop identification model.

29. The one or more storage devices of claim 27 wherein the crop identification model identifies the crop based on the location of the depiction of the crop in the at least one image.

30. The one or more storage devices of claim 27 wherein at least one model included in the crop identification model is retrained based on at least the output of the crop identification model.

31. The one or more storage devices of claim 27 wherein the crop identification model includes the second model and wherein the second model weights each respective third aspect of the plurality of third aspects based on the determined distance for the respective third aspect from each identified second aspect.

32. The one or more storage devices of claim 27 wherein the crop identification model includes the third model and wherein the third model comprises one or more of:
an object detection model; or
a segmentron model.
